(19) United States
(12) Patent Application Publication
(10) Pub. No.: US 2012/0298081 A1
(43) Pub. Date: Nov. 29, 2012

(54) INTERLOCK SAFETY SWITCH

(76) Inventors: Alonzo B. Seran, Orono, MN (US); Mark D. Shultz, Minneapolis, MN (US)

(21) Appl. No.: 13/575,533

(22) PCT Filed: Feb. 7, 2011
(86) PCT No.: PCT/US11/23879

§ 371 Date: Jul. 26, 2012

Related U.S. Application Data
(60) Provisional application No. 61/302,151, filed on Feb. 7, 2010.

(51) Int. Cl. F02P 11/00

(52) U.S. Cl. 123/630

(57) ABSTRACT

The invention provides a method of attaching a propulsion unit 12 to a scarifier 10. The device 22 verifies via a switch 24 closure that the coupler 14 and ball 16 are attached. The switch 24 is located in the tube 26 to which the ball 16 mounts. When the coupler 14 is placed on the ball 16 a spring loaded plate 28 is depressed. This plate 28 travels down with the coupler and activates the switch 24. The scarifier 10 can be configured to prevent operation unless the propulsion unit 12 is attached via the hitch. The object of this interlock is to encourage operators to use the propulsion unit in order to minimize vibration to the operator.

This application claims the benefit of U.S. Application Ser. No. 61/302,151, filed Feb. 7, 2010, and 61/299,526, filed Jan. 29, 2010, the contents of which are hereby incorporated by reference.

### TECHNICAL FIELD

### Background Art

Walk behind scarifiers for removing pavement and pavement markings are known in the art. Such devices suffer from causing substantial vibration to the operator.

### DISCLOSURE OF THE INVENTION

It is an object of this invention to provide a method of attaching a propulsion unit such as those sold by Graco Inc. under the trademark LineDriver to a scarifier. The instant invention is a device which verifies via a switch closure that the coupler and ball are attached. The switch is located in the tube to which the ball mounts. When the coupler is placed on the ball a spring loaded plate is depressed. This plate travels down with the coupler and activates the switch. This the scarifier can be configured to prevent operation unless the propulsion unit is attached via the hitch. The object of this interlock is to encourage operators to use the propulsion unit in order to minimize vibration to the operator.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows the scarifier end of the interlock system of the instant invention.

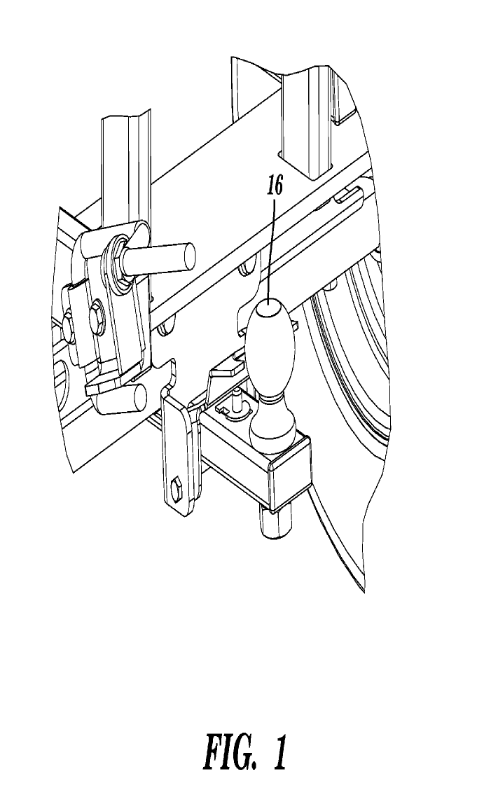

FIG. 2 shows the hitch attached to the ball of the interlock system of the instant invention.

FIG. 3 shows a cross-section of the FIG. 1 view.

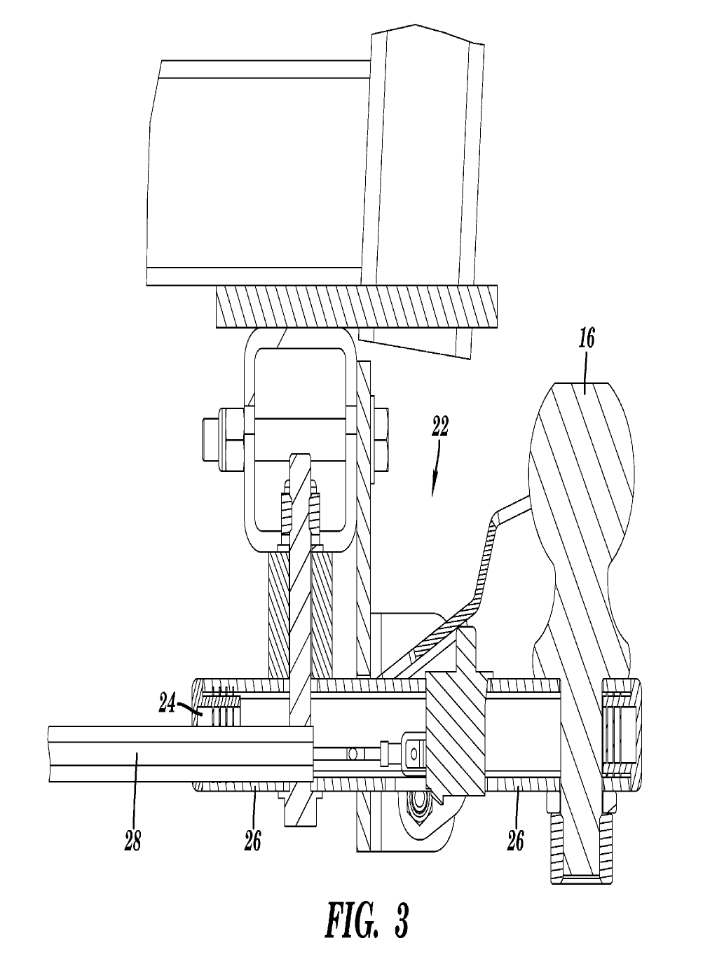

FIG. 4 shows a propulsion unit attached to a scarifier using the interlock system of the instant invention.

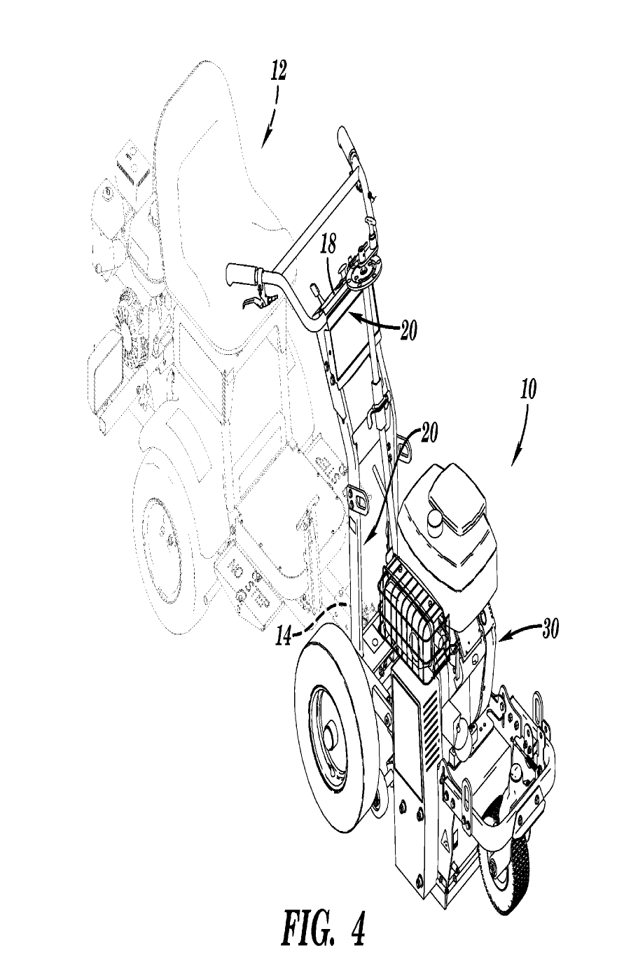

### BEST MODE FOR CARRYING OUT THE INVENTION

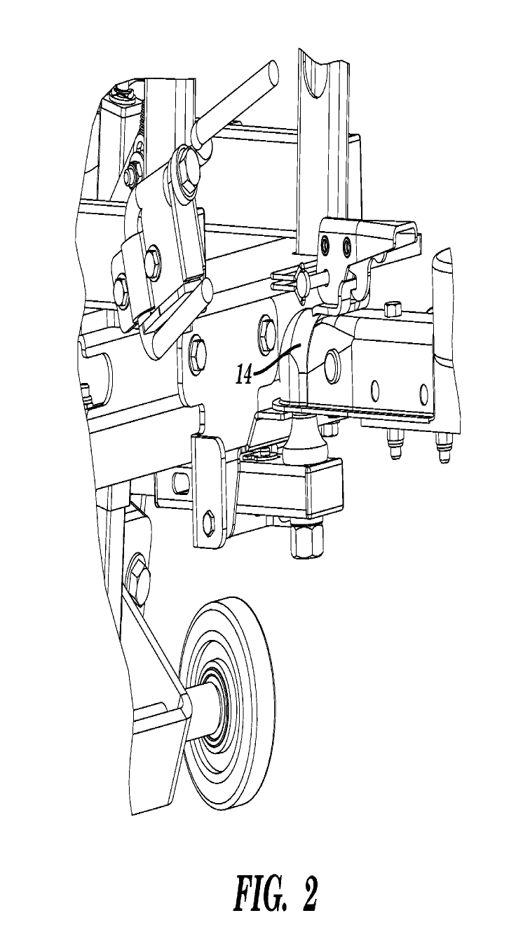

The invention provides a method of attaching a propulsion unit 12 to a scarifier 10. The interlock device 22 verifies via a switch 24 closure that the coupler 14 and ball 16 are attached. The switch 24 is located in the tube 26 to which the ball 16 mounts. When the coupler 14 is placed on the ball 16 a spring loaded plate 28 is depressed. This plate 28 travels down with the coupler (shown in FIG. 2) and activates the switch 24. While the term ball is used herein to denote a traditional hitch ball and coupler to denote the other half of the hitch, other hitch devices (pin and fork and the like) may be utilized.

The scarifier 10 can be configured to prevent operation unless the propulsion unit 12 is attached via the hitch. This can be done by including switch 24 in the ignition circuit 20 for the engine 30 of the scarifier 10. A switch 18 may be included to allow hand operation of the scarifier for certain work. The object of this interlock is to encourage operators to use the propulsion unit in order to minimize vibration to the operator.

It is contemplated that various changes and modifications may be made to the safety interlock without departing from the spirit and scope of the invention as defined by the following claims.

1. A safety interlock system for use with an engine-powered scarifier having an ignition circuit and a powered propulsion unit hitchable to said scarifier, said interlock system comprising:
a plate extending from said scarifier;
a ball mounted to said plate; and
a switch operable by depression of said plate, said switch being connected to said ignition circuit such that said scarifier in inoperable unless said plate is depressed.
